(19) United States
(12) Patent Application Publication
(10) Pub. No.: US 2006/0083725 A1
(43) Pub. Date: Apr. 20, 2006

(54) Suppression of root and tuber disease

(76) Inventor: Frank W. Dean, Spring, TX (US)

Correspondence Address: KAREN B. TRIPP, P.O. BOX 1301, HOUSTON, TX, 77251, US

(21) Appl. No.: 10/967,411

(22) Filed: Oct. 18, 2004

(51) Int. Cl. A01N 63/00

(52) U.S. Cl. 424/93.46

(57) ABSTRACT

Methods are provided for suppressing bacterial and fungal disease in roots and tubers by treating the plant tissue, seed, and surrounding soil with Bacillus firmus bacteria.

### BACKGROUND OF THE INVENTION

I. Field of the Invention

The present invention generally relates to methods to suppress bacterial and fungal disease in roots and tubers. More specifically, the present invention is directed to methods for achieving such results by treating the plant tissue, seed, and surrounding soil with Bacillus firmus bacteria.

II. Description of the Background

Potato scab (Streptomyces scabies) is a common tuber disease. The disease occurs throughout the world. Scab does not usually affect total yields. However, significant economic losses may result from reduced marketability of the tubers.

While superficial scab lesions do not greatly affect the marketability of processing potatoes deep-pitted lesions do. The disease increases peeling losses and affects the appearance of the harvested or processed product.

Scab begins when tubers start forming. Initially the spots may be so small that they cannot be seen. As the tuber grows the infected areas have reddish-brown spots that also grow. In any thimbleful of soil there may occur thousands, or even millions of individuals belonging to the genus Streptomyces. These are actinomycetes. They have characteristics placing them between bacteria and fungi. Not all of the Streptomyces organisms recovered from the soil can cause scab on potatoes. Collectively these usually are grouped under the name Streptomyces scabies. S. scabies can live on decomposing material in the soil and do not require a potato or a root crop to remain alive. The disease does become more aggressive on any given crop if the same crop is grown without rotation. The organism infects the tuber by means of a tiny thread that pushes directly through the skin of the forming potato. It slowly continues to grow until the crop is harvested. The infected areas on the potato respond at once by laying down a corky layer. As each layer is invaded by the scab organism, new cork formation takes place until a mature scab spot is produced.

Until now there has not been an economically viable and environmentally friendly method to reduce scab infection of potato.

Sudden death syndrome (SDS) is a fungal disease of soybeans caused by Fusarium solani and has caused substantial soybean yield reductions. The disease has spread over the last couple of decades. Soybean yield losses from SDS can range from slight to total. Actual yield loss depends on when plants become infected. The earlier the infection occurs in the crop life the greater the severity of the disease and the greater the loss. SDS is often first observed infesting round or elliptical patches in fields. Over time the infested area can spread through the entire field.

Disease symptoms usually appear after flowering and during pod fill. Typical foliar symptoms of SDS begin, as small chlorotic spots on leaves. The spots coalesce until the entire intervenal tissue of leaf is chlorotic. The chlorosis progresses to necrosis giving the leaves a fired look. The dead interveinal tissue falls from the leaf giving the leaf a tattered appearance. The leaf veins remain green and the leaves often drop off the plant leaving bare petioles still attached to the plant stems.

Foliar symptoms progress quickly, thus the name “sudden death.” In severely infected plants, the roots are rotted near the crown, and plants can be easily pulled from the soil. The outer cambial tissue of SDS infected stems exhibit rot but the stem's pith remains white. The causal agent of SDS, Fusarium solani, produces slow-growing blue colored fungal colonies with macroconidia on infected roots about 10 cm below the soil surface. The blue colonies sometimes can be observed with the naked eye.

The Bacillus firmus bacteria have found prior use. In U.S. Pat. No. 5,532,007 Pedersen, et al., disclosed a series of steps for hydrolysis of raw meat. The protease hydrolysis enzyme may be provided by B. firmus. The hydrolyzate can be used as a flavoring additive for soup concentrates. In U.S. Pat. No. 6,406,690 Peleg , et al., disclosed methods for controlling plant-pathogenetic nematodes which include the use of B. firmus bacteria.

Until now there have been no economically viable, or, environmentally friendly methods to suppress soil born potato scab. There are no environmentally friendly methods to suppress Soybean Sudden Death Syndrome. This invention works to solve those needs.

### SUMMARY

The present invention generally relates to methods to suppress bacterial and fungal disease in roots and tubers. More specifically, the present invention is directed to methods for achieving such results by treating the plant tissue, seed, and surrounding soil with Bacillus firmus bacteria.

### DETAILED DESCRIPTION OF THE PREFERRED EMBODIMENTS

### EXAMPLE 1

A Bacillus firmus was cultured in a liquid spore-producing medium. Once the population of spores was sufficient (10⁸ CFU's per ml) the suspension was applied to the plant soil surrounding potato plants at hilling. The treatments consisted of a control group, a group with an applied rate of a half-gallon per acre of the suspension, and, a group with an applied rate of one gallon per acre of the suspension. During the growing season samples of the tubers were harvested from the treated and untreated portions of the field and visually inspected for common potato scab. Unbelievably, the Bacillus firmus suspension treatment had no visible scab. It is believed the application of the Bacillus firmus prior to, or at, planting would further protect plants from many soil born diseases.

### EXAMPLE 2

The liquid culture produced in Example 1 was used in a replicated field trial. The material was again applied to potatoes, at hilling, at a rate of ½ gallon per acre. Several months later at harvest seventy-five tubers from each replication were pulled randomly from the field. Each tuber was inspected for deep-pitted lesions. The results are listed below.

| | Number of Deep | Percentage |
|---|---|---|
| | Pitted Lesions/150 | of Infected |
| | Tubers | Tubers |
| Untreated Soil | 12 | 8.0% |
| Treated Soil | 5 | 3.3% |

The results show a 58.3% reduction in deep-pitted scab infection with the application of Bacillus firmus to the soil during the growing season. It is believed the application of the Bacillus firmus prior to, or at, planting would further protect plants from many soil born diseases.

### EXAMPLE 3

The liquid culture produced in Example 1 was used to coat soybean seed prior to planting. The rate was 2 ounces per 100 pound of seed. Throughout the growing season the following data were collected. Using a scale of 1 to 5, with 1 being no infection and 5 being severe infection, we noticed the following in the crop. In all fields observed the average score for untreated areas were rated 2.6 for sudden death. The average score for areas treated with B. firmus in those same fields was 1.2. While the B. firmus did not completely stop the sudden death it did significantly reduce the severity on the disease. Other observations: areas treated with B. firmus had uniform emergence and even ripening. The untreated areas in these plots had uneven emergence and harvest was delayed 3 days due to uneven ripening.

### EXAMPLE 4

The liquid culture produced in Example I was blended with an admix fertilizer and applied to the seed and surrounding soil at planting. Ratings taken throughout the growing season were collected. The ratings were made for visible disease pressure from the fungus' Phytophthora, Pythium, White Mold, Sudden Death, Rhizoctonia, and, Brown stem rot. Using a rating scale from I to 10, where 10 was no infection, and 1 being severe or total field infection, the following ratings were noted:

Evaluation of Fungal Pressure on Soybean

| | Untreated with | Treated with |
|---|---|---|
| Crop Growth Stage | B. firmus | B. firmus |
| Rating of Disease Pressure | 6 | 9 |
| Emergence Through Early | | |
| Growth Stage | | |
| Mid-season Growth Stage | 5 | 9 |
| Rating of Disease Pressure | | |
| Disease Pressure Ratings | 5 | 9 |
| Prior to Harvest | | |

Discussion of Possible Components for Admixes:

For their practical application, the compounds according to this invention are rarely used on their own. Instead they generally form part of formulations which also comprise a support and/or a surfactant in addition to active materials

In the context of the invention, a support is an organic or mineral, natural or synthetic material with which the active material is associated to facilitate its application, for example, in the case of fertilizer and fungicides, to the plant, to seeds or to soil, or to facilitate its transportation or handling. The support can be solid (e.g, clays, natural or synthetic silicates, resins, waxes, solid fertilizer and fungicides) or fluid (e.g., water, alcohols, ketones, petroleum fractions, chlorinated hydrocarbons, liquefied gases, liquid fertilizer and fungicides).

The surfactant can be an ionic or non-ionic emulsifier, dispersant or wetting agent such as, for example, salts of polyacrylic acids and lignin-sulphonic acids, condensates of ethylene oxide with fatty alcohols, fatty acids or fatty amines.

The compositions comprising the compounds of the present invention can be prepared in the form of wettable powders, soluble powders, dusting powders, granulates, solutions, emulsifiable concentrates, emulsions, suspended concentrates and aerosols.

The wettable powders according to the invention can be prepared in such a way that they contain the active material, and they often or typically contain, in addition to a solid support, a wetting agent, a dispersant and, when necessary, one or more stabilizers and/or other additives, such as, for example, penetration agents, adhesives or anti-lumping agents, colorants etc.

Aqueous dispersions and emulsions, such as, for example, compositions comprising the compounds of this invention obtained by diluting with water a wettable powder or an emulsifiable concentrate are also included within the general scope of the invention. These emulsions can be of the water-in-oil type or of the oil-in-water type, and can have a thick consistency resembling that of a “mayonnaise”.

The compositions comprising the compounds of the present invention can contain other ingredients, for example protective colloids, adhesives or thickeners, thixotropic agents, stabilizers or sequestrants, as well as other active materials. A modest list of examples of possible formulation components for inclusion with the compositions of this invention follows without limitation.

Carbon Skeleton/Energy (CSE) Components:

The supposed function of this component is to supply carbon skeleton for synthesis of proteins and other molecules or to supply energy for metabolism. Water-soluble carbohydrates such as sucrose, fructose, glucose and other di- and monosaccharides are suitable, commonly in the form of molasses or other by-products of food manufacture. Commercially available lignosulfonates, discussed below under the heading “Complexing Agents,” are also suitable as a CSE source inasmuch as they commonly contain sugars.

CSE Components:

Sugar—mannose, lactose, dextrose, erythrose, fructose, fucose, galactose, glucose, gulose, maltose, polysaccharide, raffinose, ribose, ribulose, rutinose, saccharose, stachyose, trehalose, xylose, xylulose, adonose, amylose, arabinose, fructose phosphate, fucose-p, galactose-p, glucose-p, lactose-p, maltose-p, mannose-p, ribose-p, ribulose-p, xylose-p, xylulose-p, deoxyribose, corn steep liquor, whey, corn sugar, corn syrup, maple syrup, grape sugar, grape syrup, beet sugar, sorghum molasses, cane molasses, mineral salts lignosulfonate sugar alcohol—adonitol, galactitol, glucitol, maltitol, mannitol, mannitol-p, ribitol, sorbitol, sorbitol-p, xylitol xxxx acids—glucuronic acid, a-ketoglutaric acid, galacturonic acid, glutaric acid, gluconic acid, pyruvic acid, poly galacturonic acid, saccharic acid, citric acid, succinic acid, malic acid, oxaloacetic acid, aspartic acid, phosphoglyceric acid, fulvic acid, ulmic acid, humic acid, glutamic acid.

Nucleotides and bases—adenosine, adenosine-p, adenosine-p-glucose, uridine, uridine-p, uridine-p-glucose, thymine, thymine-p, cytosine, cytosine-p, guanosine, guanosine-p, guanosine-p-glucose, guanine, guanine-p, NADPH, NADH, FMN, FADH

The Macronutrient Components:

The macronutrients are essential to nutrition and growth. The most important macronutrients are N, P and K. Some example nitrogen compounds are: ammonium nitrate, monoammonium phosphate, ammonium phosphate sulfate, ammonium sulfate, ammonium phosphatenitrate, diammonium phosphate, ammoniated single superphosphate, ammoniated triple superphosphate, nitric phosphates, ammonium chloride, aqua ammonia, ammonia-ammonium nitrate solutions, mineral salts ammonium nitrate, mineral salts nitrate, mineral salts Cyanamid, sodium nitrate, urea, urea-formaldehyde, urea-ammonium nitrate solution, nitrate of soda potash, potassium nitrate, amino acids, proteins, nucleic acids.

Example of Phosphate sources include: superphosphate (single, double and/or triple), phosphoric acid, ammonium phosphate, ammonium phosphate sulfate, ammonium phosphate nitrate, diammonium phosphate, ammoniated single superphosphate, ammoniated single superphosphate, ammoniated triple superphosphate, nitric phosphates, potassium pyrophosphates, sodium pyrophosphate, urea phosphate, urea phosphite, nucleic acid phosphates and phosphonic and phosphorous acid derivatives.

The potassium ion for example can be found in: potassium chloride, potassium sulfate, potassium gluconate, sulfate of potash magnesia, potassium carbonate, potassium acetate, potassium citrate, potassium hydroxide, potassium manganate, potassium phosphate, potassium molybdate, potassium thiosulfate, potassium zinc sulfate and the like.

Mineral salts sources include for example: mineral salts ammonium nitrate, mineral salts nitrate, mineral salts Cyanamid, mineral salts acetate, mineral salts acetylsalicylate, mineral salts borate, mineral salts borogluconate, mineral salts carbonate, mineral salts chloride, mineral salts citrate, mineral salts ferrous citrate, mineral salts glycerophosphate, mineral salts lactate, mineral salts oxide, mineral salts pantothenate, mineral salts propionate, mineral salts saccharate, mineral salts sulfate, mineral salts tartrate and the like.

Magnesium can be found for example in: magnesium oxide, dolomite, magnesium acetate, magnesium benzoate, magnesium bisulfate, magnesium borate, magnesium chloride, magnesium citrate, magnesium nitrate, magnesium phosphate, magnesium salicylate, magnesium sulfate.

Sulfur containing compounds include for example: ammonium sulfate, ammonium phosphate sulfate, mineral salts sulfate, potassium sulfate, magnesium sulfate, sulfuric acid, cobalt sulfate, copper sulfate, ferric sulfate, ferrous sulfate, sulfur, cysteine, methionine and elemental sulfur.,

Micronutrient Components:

The most important micronutrients are or comprise: Zn, Fe, Cu, Mn, B, Co, and Mo.

Vita/Cofactor Components:

The most important are folic acid, biotin, pantothenic acid, nicotinic acid, riboflavin and thiamine and include for example: Thiamine—thiamine pyrophosphate, thiamine monophosphate, thiamine disulfide, thiamine mononitrate, thiamine phosphoric acid ester chloride, thiamine phosphoric acid ester phosphate salt, thiamine 1,5 salt, thiamine tri phosphoric acid ester, thiamine tri phosphoric acid salt, yeast, yeast extract Riboflavin—riboflavin acetyl phosphate, flavin adenine dinucleotide, flavin adenine mononucleotide, riboflavin phosphate, yeast, yeast extract. Nicotinic acid—nicotinic acid adenine dinucleotide, nicotinic acid amide, nicotinic acid benzyl ester, nicotinic acid monoethanolamine salt, yeast, yeast extract, nicotinic acid hydrazide, nicotinic acid hydroxamate, nicotinic acid-N-(hydroxymethyl)amide, nicotinic acid methyl ester, nicotinic acid mononucleotide, nicotinic acid nitrile. Pyridoxine—pyridoxal phosphate, yeast, yeast extract Folic acid—yeast, yeast extract, folinic acid. Biotin—biotin sulfoxide, yeast, yeast extract, biotin 4-amidobenzoic acid, biotin amidocaproate N-hydroxysuccinimide ester, biotin 6-amidoquinoline, biotin hydrazide, biotin methyl ester, d-biotin-N-hydroxysuccinimide ester, biotin-maleimide, d-biotin p-nitrophenyl ester, biotin propranolol, 5-(N-biotinyl)-3 aminoallyl)uridine 5′-triphosphate, biotinylated uridine 5′-triphosphate, N-e-biotinyl-lysine. Pantothenic acid—yeast, yeast extract, coenzyme A, Cyanocobalamin—yeast, yeast extract. Phosphatidylcholine-soybean oil, eggs bovine heart, bovine brain, bovine liver, L-a-phosphatidylcholine, B-acetyl-g-O-alkyl, D-a-phosphatidylcholine(PTCn), B-acetyl-g-O-hexadecyl, DL-a-PTCh, B-acetyl-g-O-hexadecyl, L-a-PTCh, B-acetyl-g-O-(octadec-9-cis-enyl), L-a-PTCh, B-arachidonoyl, g-stearoyl, L-a-PTCh, diarachidoyl, L-a-PTCh, dibehenoyl (dibutyroyl, dicaproyl, dicapryloyl, didecanoyl, dielaidoyl, 12 diheptadecanoyl, diheptanoyl), DL-a-PTCh dilauroyl, L-a-PTCh dimyristoyl (dilauroyl, dilinoleoyl, dinonanoyl, dioleoyl, dipentadeconoyl, dipalmitoyl, distearoyl, diundecanoyl, divaleroyl, B-elaidoyl-a-palmitoyl, B-linoleoyl-a-palmitoyl) DL-a-PTCh di-O-hexadecyl (dioleoyl, dipalmitoyl, B-O-methyl-g-O-hexadecyl, B-oleoyl-g-O-hexadecyl, B-palihtoyl-g-O-hexadecyl), D-a-PTCh dipalmitoyl, L-a-PTCh, B-O-methyl-g-O-octadecyl, L-a-PTCh, B-(NBD-aminohexanoyl)-g-palmitoyl, L-a-PTCh, B-oleoyl-g-O-palmitoyl (stearoyl), L-a-PTCh, B-palmitoyl-g-oleoyl, L-a-PTCh, B-palmitoyl-a-(pyren 1-yl) hexanoyl, L-a-PTCh, B(pyren-1-yl)-decanoyl-g-palmitoyl, L-a-PTCh, B-(pyren-1-yl)-hexanoyl-g-palmitoyl, L-a-PTCh, B-stearoyl-g-oleoyl. Inositol—inositol monophosphate, inositol macinate, myo-inositol, epi-inositol, myo-inositol 2,2′anhydro-2-c-hydroxymethyl (2-c-methylene-myoinositol oxide), D-myo-inositol 1,4-bisphosphate, DL-myo-inositol 1,2-cyclic monophosphate, myo-inositol dehydrogenase, myo-inositol hexanicotinate, inositol hexaphosphate, myo-inositol hexasulfate, myo-inositol 2-monophosphate, D-myo-inositol 1-monophosphate, DL-myo-inositol 1-monophosphate, D-myo-inositol triphosphate, scyllo-inositol PABA—m-aminobenzoic acid, O-aminobenzoic acid, p-aminobenzoic acid butyl ester, PABA ethyl ester, 3-ABA ethyl ester.

Complexing Agents:

The function of this component, particularly in agricultural applications, aside from its proposed use as a Carbon skeleton agent, is to solubilize other components of the composition which otherwise may precipitate and become assailable or may immobilize minerals in the soil which might otherwise be unavailable to flora and fauna. Complexing agents such as, for example, citric acid, humic acids, lignosulfonate, etc. serve to tie up ions such as iron and prevent them from forming precipitates. In some cases this complexing is by way of chelation. These agents may form complexes with the following compounds for example: Citric acid; Ca, K, Na and ammonium lignosulfonates, fulvic acid, ulmic acid, humic acid, Katy-J, EDTA, EDDA(ethylenediaminedisuccinic acid), EDDHA, HEDTA, CDTA, PTPA, NTA, MEA, IDS, EDDS, and 4-phenylbutyric acid.

Other complexing agents include for example: Al and its salts, Zn—zinc oxide, zinc acetate, zinc benzoate, zinc chloride, zinc citrate, zinc nitrate, zinc salicylate, ziram Fe—ferric chloride, ferric citrate, ferric fructose, ferric glycerophosphate, ferric nitrate, ferric oxide (saccharated), ferrous chloride, ferrous citrate ferrous fumarate, ferrous gluconate, ferrous succinate. Mn—manganese acetate, manganese chloride, manganese nitrate, manganese phosphate, Cu—cupric acetate, cupric butyrate, cupric chlorate, cupric chloride, cupric citrate, cupric gluconate, cupric glycollate, cupric nitrate, cupric salicylate, cuprous acetate, cuprous chloride. B—mineral salts borate, potassium borohydride, borax, boron trioxide, potassium borotartrate, potassium tetraborate, sodium borate, sodium borohydride, sodium tetraborate and boric acid. Mo—molybdic acid, mineral salts molybdate, potassium molybdate, sodium molybdate. Co—cobaltic acetate, cobaltous acetate, cobaltous chloride, cobaltous oxalate, cobaltous potassium sulfate, cobaltous sulfate.

Growth Regulators:

Seaweed extract—kelp extract, Kinetin, Kinetin riboside, benzyladenine, zeatin riboside, zeatin, extract of corn cockle, isopentenyl adenine, dihydrozeatin, indoleacetic acid, phenylacetic acid, IBA, indole ethanol, indole acetaldehyde, indoleacetonitrile, indole derivitives, gibberellins (e.g. GA1, GA2, GA3, GA4, GA7, GA38 etc.) polyamines, monoethanolamine, allopurinol, GA inhibitors, ethylene inducing compounds, ethylene biosynthesis inhibitors, GABA, anticytokinins and antiauxins, ABA inducers and inhibitors, and other known growth regulators.

Gum Components:

Xanthan gum—guar gum, gum agar, gum accroides, gum arabic, gum carrageenan, gum damar, gum elemi, gum ghatti, gum guaiac, gum karya, locust bean gum, gum mastic, gum pontianak, gum rosin, gum storax, gum tragacanth

Microbialstats, Proprionic Acid, Benzoic Acid, Sorbic Acid and Amino Acids

Buffers

Phosphate buffer, formate or acetate buffer, AMP buffer, mineral salts tartrate, glycine buffer, phosphate citrate buffer, tris buffer, ECT.

If desired, a formulation or composition of the present invention may also include beneficial microorganisms. The compositions comprising the compounds of the present invention thus defined may be applied to plants by conventional methods including seed application techniques, as well as foliar methods.

The foregoing description of the invention has been directed in primary part to particular preferred embodiments in accordance with the requirements of the Patent Statutes and for purposes of explanation and illustration. It will be apparent, however, to those skilled in the art that many modifications and changes in the specifically described methods may be made without departing from the true scope and spirit of the invention. Therefore, the invention is not restricted to the preferred embodiments described and illustrated but covers all modifications, which may fall within the scope of the following claims.

I claim:

1) The application of Bacillus firmus to seed for the suppression of root and tuber disease in plants.

2) The application of Bacillus firmus to soil for the suppression of root and tuber disease in plants.

3) The application of Bacillus firmus to plant tissue for the suppression of root and tuber disease in plants.

4) The blending of Bacillus firmus with an admix for application to soil, seed, and plant tissue.

5) A method for preventing or suppressing bacterial and/or fungal disease in roots or tubers of plants, said method comprising applying a composition comprising Bacillus firmus to the soil containing or that will contain the roots or tubers.

6) The method of claim 5 wherein the concentration of Bacillus firmus in said composition is at least about 10⁶ CFU's per ml.

7) The method of claim 5 wherein said composition farther comprises fertilizer.

8) The method of claim 5 wherein said disease is scab infection in plant tubers.

9) The method of claim 5 further comprising applying a composition comprising Bacillus firmus to the foliage of the plants.

10) A method for preventing or suppressing bacterial and/or fungal disease in roots or tubers of plants, said method comprising applying a composition comprising Bacillus firmus to the seeds of said plants prior to planting said seeds in soil.

11) The method of claim 10 wherein said seeds are soybean seeds.

12) The method of claim 11 wherein said disease is Soybean Sudden Death Syndrome.

13) The method of claim 10 wherein the concentration of Bacillus firmus in said composition as applied to the seeds is about 2 ounces Bacillus firmus per 100 pounds of seeds.

14) The method of claim 10 wherein said composition further comprises fertilizer.

15) The method of claim 10 further comprising planting said seeds in soil and applying a composition comprising Bacillus firmus to the soil containing the seeds or planting said seeds in soil to which a composition comprising Bacillus firmus has already been applied.

16) The method of claim 10 further comprising planting said seeds allowing said seeds to sprout, and applying a composition comprising Bacillus firmus to the foliage.

17) The method of claim 10 wherein said composition further comprises fertilizer.

18) A method for preventing or suppressing bacterial and/or fungal disease in plants, said method comprising applying a composition comprising Bacillus firmus to the plant foliage or tissue.

19) The method of claim 18 wherein said composition further comprises fertilizer.

20) A plant bacterial and/or fungal disease suppressing composition comprising Bacillus firmus.

21) The composition of claim 20 further comprising fertilizer.

22) The composition of claim 20 further comprising an admix for application to soil, seed, and/or plant tissue.

23) The composition of claim 22 wherein said admix is selected from the group consisting of: support comprising organic or mineral material; surfactants, dispersants, wetting agents, protective colloids, adhesives, thickeners, thixotropic agents, stabilizers, sequestrants, carbon skeleton energy components, macronutrient components, micronutrient components vitamin cofactor components, complexing agents, growth regulators, gum components, microbialstats, proprionic acid, benzoic acid, sorbic acid, amino acids, buffers; and combinations thereof.

24) The composition of claim 20 wherein the concentration of Bacillus firmus in the composition is at least about 10⁶ CFU's per ml.
